(19) United States
(12) Patent Application Publication
(10) Pub. No.: US 2019/0316929 A1
(43) Pub. Date: Oct. 17, 2019

(54) SYSTEM AND METHOD FOR VEHICULAR LOCALIZATION RELATING TO AUTONOMOUS NAVIGATION

(71) Applicant: Faraday&Future Inc., Gardena, CA (US)

(72) Inventors: Kwang Keun J. SHIN, Torrance, CA (US); Dae Jin KIM, Rancho Palos Verdes, CA (US); Hong S. BAE, Torrance, CA (US)

(21) Appl. No.: 15/955,524

(22) Filed: Apr. 17, 2018

(51) Int. Cl. G01C 21/36; G05D 1/02; G05D 1/00

(52) U.S. Cl. CPC G01C 21/3644; G05D 1/0219; G05D 1/0088; G05D 1/0274; G05D 1/0278; G05D 1/0248

(57) ABSTRACT

A system for use in a vehicle, the system comprising one or more sensors; one or more processors coupled to the one or more sensors; and a memory including instructions, which when executed by the one or more processors, cause the one or more processors to perform a method. The method comprising determining an estimated location of the vehicle, obtaining map information based on the estimated location of the vehicle, obtaining sensor information relating the vehicle's proximate surroundings from the one or more sensors, detecting a first landmark and a second landmark in physical proximity to the vehicle based on the sensor information, and localizing the vehicle location based on the map information and the first and second landmarks.

### FIELD OF THE DISCLOSURE

This relates generally to vehicle localization for autonomous vehicle navigation.

### BACKGROUND OF THE DISCLOSURE

Vehicles, especially automobiles, increasingly include various systems and sensors for determining the vehicle's location. Current localization techniques for vehicles include Global Positioning Systems (GPS) and dead reckoning. GPS techniques (including Global Navigation Satellite Systems (GNSS)), however, can result in some uncertainty under certain conditions. For example, GPS localization can be inaccurate because of signal blockage (e.g., due to tall buildings, being in a tunnel or parking garage), signal reflections off of buildings, or atmospheric conditions. Moreover, dead reckoning techniques can be imprecise and can accumulate error as the vehicle travels. Accurate localization of a vehicle, however, is critical to achieve safe autonomous vehicle navigation. Therefore, a solution to enhance localization techniques for autonomous vehicle navigation can be desirable.

### SUMMARY OF THE DISCLOSURE

Examples of the disclosure are directed to enhancing localization techniques for safe autonomous driving navigation. A system in accordance with a preferred embodiment of the present invention estimates a current location and heading of a vehicle using a location system such as GPS, and analyzes on-board sensor information relating to the vehicle's surroundings, such as LIDAR and/or camera data. In accordance with one embodiment, the system uses the location information to retrieve map information related to the estimated location of the vehicle including information about landmarks (e.g., location, type, dimensions) within the vicinity the vehicle's estimated location. In accordance with one embodiment, the map information and sensor information are used by the system to enhance the estimated location and heading of the vehicle. For example, the system analyzes map information and the sensor information to perform map matching of the landmarks described in the map information to the landmarks detected by the vehicle's onboard sensors and then determines the vehicle's position and orientation relative to the landmarks identified in the retrieved map information. By determining the vehicle's position and orientation relative to the landmarks described in the map, which includes the location of the landmarks (e.g., latitude and longitude coordinates, X and Y coordinates within the map), the system improves the precision and accuracy of the estimated location and heading of the vehicle. In this way, the vehicle can more safely navigate around the geographic area described by the map.

### BRIEF DESCRIPTION OF THE DRAWINGS

FIG. 1 illustrates a system block diagram of a vehicle control system according to examples of the disclosure.

FIG. 2 illustrates a vehicle navigating along a road according to examples of the disclosure.

FIG. 3 illustrates a vehicle navigating within a parking lot according to examples of the disclosure.

FIG. 4 illustrates a process for determining the location and heading of a vehicle according to examples of the disclosure.

FIG. 5A illustrates a vehicle sensor information according to examples of the disclosure.

FIG. 5B illustrates location information configured according to examples of the disclosure.

FIG. 5C illustrates a localized vehicle within a map according to examples of the disclosure.

FIG. 6 illustrates a process for localizing a vehicle within a map according to examples of the disclosure.

### DETAILED DESCRIPTION

In the following description of examples, references are made to the accompanying drawings that form a part hereof, and in which it is shown by way of illustration specific examples that can be practiced. It is to be understood that other examples can be used and structural changes can be made without departing from the scope of the disclosed examples. Further, in the context of this disclosure, “autonomous driving” (or the like) can refer to autonomous driving, partially autonomous driving, and/or driver assistance systems.

Autonomous vehicles can use location and heading information for performing autonomous driving operations. Examples of the disclosure are directed to using map information and sensor information for enhancing autonomous vehicle navigation. For example, a system in accordance with a preferred embodiment of the present invention can estimate a current location and heading of a vehicle using a location system such as GPS, and analyze on-board sensor information relating to the vehicle's surroundings, such as LIDAR and/or camera data. The system can use this information to retrieve a map containing information about the estimated location of the vehicle. In some examples, the map information can be retrieved from an external source (e.g., a server, another vehicle). In some examples, the system can retrieve this map from local memory. In some examples, the map is a two dimensional map. In some examples, the map is a three dimensional map. The map information can include information about one or more landmarks (e.g., latitude and longitude coordinates, X and Y coordinates of the landmarks within the map, the dimensions of the one or more landmarks, type of landmark for each of the one or more landmarks, the distance between each landmark). The vehicle can use the map information and the sensor information to identify and locate one or more landmarks within the vehicle's vicinity. For example, the vehicle can determine its position and orientation relative to the landmark(s), as will be discussed in further detail below. Using this additional location information, the vehicle can more accurately determine its location and heading by matching the landmarks in the map to the landmarks detected by the vehicle's sensors, as described in further detail below. In this way, the vehicle can more safely navigate itself within the area described by the map.

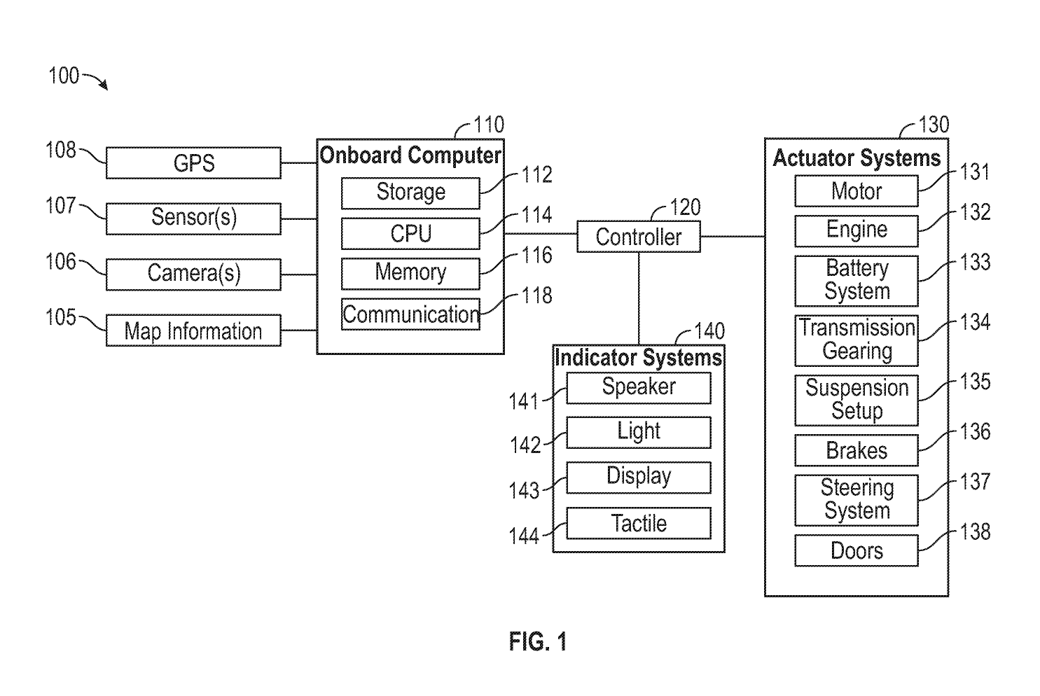

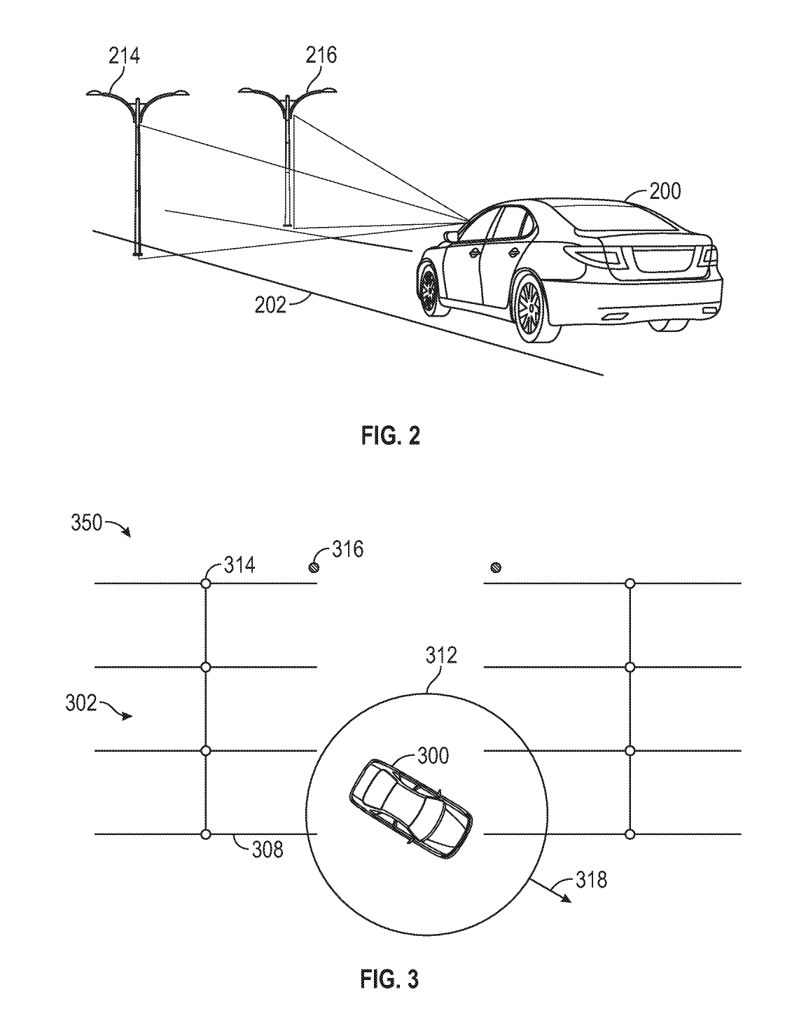

FIG. 1 illustrates a system block diagram of vehicle control system 100 according to examples of the disclosure. Vehicle control system 100 can perform each of the methods described with reference to FIGS. 2-6. Vehicle control system 100 can be incorporated into a vehicle, such as a consumer automobile. Other examples of vehicles that may incorporate the vehicle control system 100 include, without limitation, airplanes, boats, or industrial automobiles. In accordance with an embodiment, vehicle control system 100 includes one or more cameras 106 for determining one or more characteristics about the vehicle's surroundings, as described below with reference to FIGS. 2-6. Vehicle control system 100 can also include one or more other sensors 107 (e.g., radar, ultrasonic, laser, LIDAR, accelerometer, gyroscope, pressure, temperature, speed, air flow, or smoke) and a Global Positioning System (GPS) receiver 108 for detecting various characteristics about the vehicle and about the vehicle's surroundings. In some examples, sensor data can be fused (e.g., combined) at one or more electronic control units (ECUs) (not shown). The particular ECU(s) that are chosen to perform data fusion can be based on an amount of resources (e.g., processing power and/or memory) available to the one or more ECUs, and can be dynamically shifted between ECUs and/or components within an ECU (since an ECU can contain more than one processor) to optimize performance. In accordance with another embodiment, vehicle control system 100 receives map information via a map information interface 105 (e.g., a cellular Internet interface or a Wi-Fi Internet interface).

A vehicle control system 100 according to an embodiment of the present invention can include an on-board computer 110 that is coupled to cameras 106, sensors 107, GPS receiver 108, and map information interface 105, and that is capable of receiving the image data from the cameras and/or outputs from the sensors 107, the GPS receiver 108, and the map information interface 105. On-board computer 110 can include storage 112, memory 116, communications interface 118, and a processor 114. Processor 114 can perform any of the methods described with references to FIGS. 2-6. Additionally, communications interface 118 can perform any of the communications described with reference to FIGS. 2-6. Moreover, storage 112 and/or memory 116 can store data and instructions for performing any or all of the methods described with references to FIGS. 2-6. Storage 112 and/or memory 116 can be any non-transitory computer-readable storage medium, such as a solid-state drive or a hard disk drive, among other possibilities. In accordance with one embodiment, the vehicle control system 100 includes a controller 120 capable of controlling one or more aspects of vehicle operation, such as performing autonomous or semi-autonomous driving maneuvers.

In some examples, vehicle control system 100 is electrically connected (e.g., via controller 120) to one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137, and door system 138. Vehicle control system 100 controls, via controller 120, one or more of these actuator systems 130 during vehicle operation; for example, to open or close one or more of the doors of the vehicle using the door actuator system 138, to control the vehicle during autonomous driving operations, using the motor 131 or engine 132, battery system 133, transmission gearing 134, suspension setup 135, brakes 136, and/or steering system 137, etc. According to one embodiment, actuator systems 130 includes sensors that send dead reckoning information (e.g., steering information, speed information, etc.) to on-board computer 110 (e.g., via controller 120) to estimate the vehicle's location and heading. The one or more indicator systems 140 can include, but are not limited to, one or more speakers 141 in the vehicle (e.g., as part of an entertainment system in the vehicle), one or more lights 142 in the vehicle, one or more displays 143 in the vehicle (e.g., as part of a control or entertainment system in the vehicle), and one or more tactile actuators 144 in the vehicle (e.g., as part of a steering wheel or seat in the vehicle). Vehicle control system 100 can control, via controller 120, one or more of these indicator systems 140 to provide indications to a driver.

FIG. 2 illustrates vehicle 200 navigating along road 202 according to examples of the disclosure. Vehicle 200 includes at least one or more of the Global Navigation Satellite Systems (GNSS) (e.g., GPS, BeiDou, Galileo, etc.), inertial navigation systems (INS) (e.g., inertial guidance systems, inertial instruments, inertial measurement units (IMU)), and/or sensors (e.g., accelerometers, gyroscopes, magnetometers) for determining the vehicle's location and heading (e.g., as described above with references to FIG. 1). Vehicle 200 also includes one or more of the various sensors and systems for determining one or more characteristic about the vehicle's surroundings along route 202 (e.g., as described above with references to FIG. 1). These sensors can include LIDAR sensors, cameras (e.g., stereo-cameras, mono-cameras), radar sensors, ultrasonic sensors, laser sensors, or any other sensors that can be used to detect one or more characteristics about the vehicle's surroundings. These sensors can be configured on vehicle 200 to provide it with 360 degree (or other) coverage of the area surrounding the vehicle. For example, vehicle 200 can process data from one or more of these sensors to identify landmarks such as light-poles 214 and 216. In some examples, vehicle 200 can be configured to identify other landmarks including signal-poles, telephone poles, power-line poles, traffic signs, street signs, traffic signals, trees, lane dividers, road markings (e.g., lane markers, parking spot markers, direction markers), pillars, file hydrants, or any other fixed object or structure that can serve as a landmark for a geographic area.

Vehicle 200 can be configured to autonomously drive along road 202 using sensor and map information. For example, vehicle 200 can use its positioning systems (e.g., GPS, INS) to estimate its location and orientation. The vehicle's onboard computer (e.g., as described above with reference to FIG. 1) can then load map information based on that estimated location (e.g., from local memory or via a wireless connection to a server, another vehicle, a computer, or another device). In some examples, the map information can include information about road 202 and about landmarks 214 and 216 (e.g., latitude and longitude coordinates, the X and Y coordinates of each of the landmarks, the types of each of the landmarks, the dimensions of each of the landmarks, the distance between each of the landmarks). In some examples, vehicle's onboard computer can process sensor information to determine the distance and angle (relative to the heading of the vehicle) from the vehicle to each of landmarks 214 and 216. This sensor information can include information from LIDAR sensors, cameras, radar sensors, ultrasonic sensors, laser sensors, and/or any other sensors that can be used to detect one or more characteristics about the vehicle's surroundings. The vehicle's onboard computer can then use the map information and the sensor information to determine the vehicle's location and heading within the map by matching the positions of the landmarks in the map to the position of the same landmarks detected by the vehicle's sensors. This can help determine the vehicle's location and heading more accurately than simply using GPS and/or dead reckoning techniques. For example, determining the vehicle's position and orientation relative to the landmarks, whose fixed locations are known, can verify or correct the vehicle's estimated location and heading based on GPS and/or dead reckoning techniques.

FIG. 3 illustrates vehicle 300 navigating within map 350 according to examples of the disclosure. In this example, map 350 (not drawn to scale) represents a parking lot that includes a plurality of parking spots 302, light-posts 314, and pillars 316. In other examples, map 350 can represent an intersection, a road, a garage, a road with curbside parking, a driveway, or any geographic location with designated areas for driving and/or parking. Vehicle 300 can include various systems and sensors (e.g., GPS, INS) for estimating the vehicle's location and heading (e.g., as described above with reference to FIGS. 1-2). The vehicle's estimated location can be represented by error bounds 312 (e.g., the area in which the vehicle is likely located) and estimated heading 318. The larger the area of error bounds 312 the more uncertainty in the vehicle's location estimate. This can be problematic for autonomous vehicle navigation—particularly for navigating within a parking lot or at an intersection. For example, parking lot 350 can be surrounded by tall buildings (not shown) which can cause inaccuracies with GPS location determinations due to signal blockage or signal reflections—increasing the area of error bounds 312. An inaccurate location determination, however, can be corrected using map and sensor information as described below. How the vehicle's onboard computer identifies and loads this map information is described next.

To obtain the necessary map information, vehicle 300 is configured to identify and load map 350 based on the vehicle's estimated location (e.g., error bounds 312) (e.g., as described above with reference to FIG. 2). In some examples, vehicle 300's onboard computer can send a request (e.g., through vehicle-to-vehicle, Internet, cellular, radio, or any other wireless communication channels and/or technologies) for a map containing the area represented by error bounds 312 to an outside source (e.g., a server, another vehicle). In other examples, vehicle 300 can be configured to store maps in its local memory (e.g., in a database, a hash table, a binary search tree, a data file, an XML, file, or a binary decision diagram). In this way, the vehicle's onboard computer can perform a map look up operation for a map containing error bounds 312 within local memory. The computer's onboard computer can then use this map information to correct the vehicle's estimated location and heading, as described in further detail below.

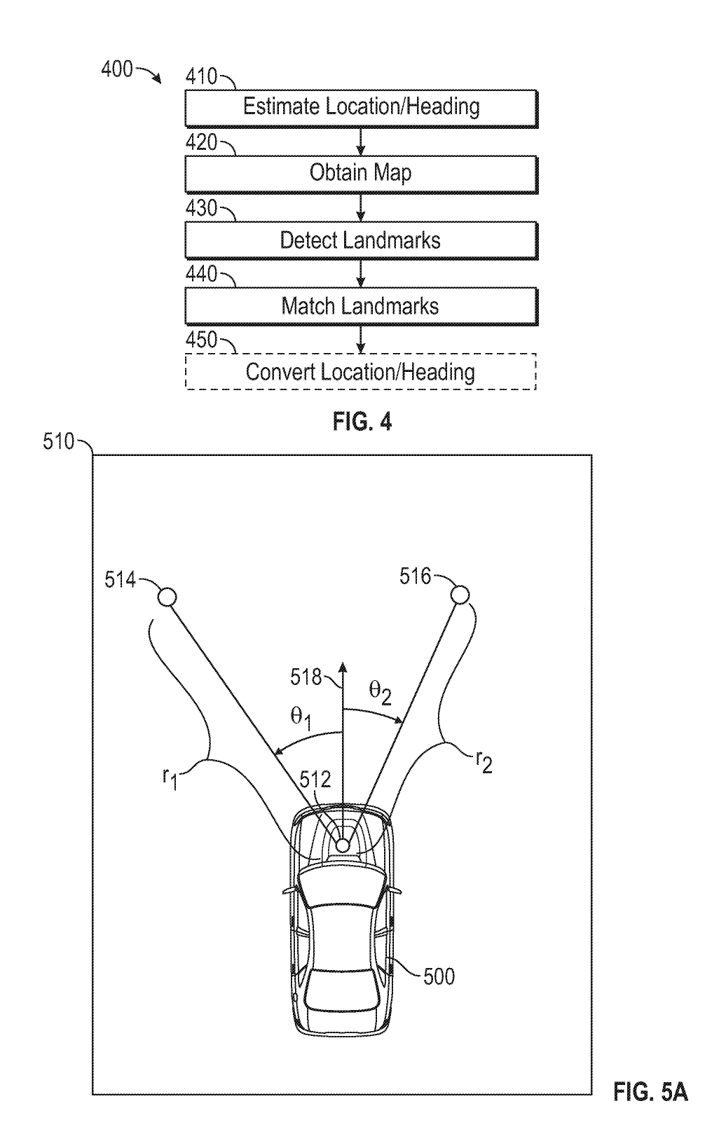

FIG. 4 illustrates process 400 for determining the location and heading of a vehicle according to examples of the disclosure. At step 410, an estimate location and heading of a vehicle can be determined. As described above, the vehicle's location can be estimated with GPS, dead reckoning, and/or any other techniques that can be used to estimate a vehicle's location. The vehicle's estimated location can be represented by an error bounds—the area in which the vehicle is likely located (e.g., as described above with reference to FIG. 3).

At step 420, a map of the area surrounding the vehicle's estimated location is obtained. For example, a look up operation can be performed for a map that contains the estimated location of the vehicle (e.g., the error bounds). In some examples, the lookup operation can be performed locally (e.g., from the memory or storage of the vehicle's onboard computer). In some examples, the lookup operation can be performed remotely. For example, a request for map information can be sent (e.g., through vehicle-to-vehicle, Internet, cellular, radio, or any other wireless communication channels and/or technologies) to an outside source (e.g., a server, another vehicle). In response to the request, a map containing the vehicle's estimated location can be received. The map obtained at step 420 can include information about one or more landmarks (e.g., latitude and longitude coordinates, the X and Y coordinates of each of the landmarks, the types of each of the landmarks, the dimensions of each of the landmarks, the distance between each of the landmarks). These landmarks can include light-poles, signal-poles, telephone poles, power-line poles, traffic signs, street signs, traffic signals, trees, lane dividers, road markings (e.g., lane markers, parking spot markers, direction markers), pillars, file hydrants, or any other fixed object or structure within a geographic area.

At step 430, two or more landmarks surrounding the vehicle are detected. For example, the vehicle's sensors are used gather sensor information about one or more characteristics about the vehicle's surroundings. The sensor information can include data from LIDAR sensors, cameras (e.g., stereo-cameras, mono-cameras), radar sensors, ultrasonic sensors, laser sensors, and/or any other sensors that can be used to detect one or more characteristics about the vehicle's surroundings. In some examples, a LIDAR sensor can be used to detect one or more characteristics about the vehicle's surroundings and to classify objects or structures around the vehicle as a particular landmark type (e.g., as a light-pole, signal-pole, telephone pole, power-line pole, traffic sign, street sign, traffic signal, tree, lane divider, road marking, pillar, file hydrant, building, wall, fence). In some examples, cameras can be used to detect one or more objects or structures surrounding the vehicle and to classify objects or structures as a particular landmark type. In some examples, process 400 can first use a LIDAR sensor to detect one or more objects or structures surrounding the vehicle and use one or more cameras (or a sensor other than a LIDAR sensor) to classify each of the one or more objects or structures as a particular landmark type.

In some examples, at step 430, process 400 can use sensor information to detect two or more landmarks within the error bounds obtained from step 410. For example, process 400 can first identify landmarks in the map information that are located within the area defined by the error bounds and then use sensor information to detect two of more of those landmarks. In some examples, process 400 can first use sensor information to detect landmarks around the vehicle and select two or more of the detected landmarks contained within the area defined by the error bounds. In some examples, process 400 can use sensor information to detect two or more landmarks outside the error bounds obtained from step 410. In some examples, process 400 can use sensor information to detect one or more landmarks within the error bounds and to detect one or more landmarks outside the error bounds (e.g., to detect at least one landmark within the error bounds and at least one landmark outside of the error bounds).

In some examples, step 430 can be performed before step 410. In some examples, step 430 can be performed after step 410 and before step 420. In some examples, step 430 can be performed concurrently with steps 410 and/or 420.

At step 440, process 400 matches two or more of the landmarks detected at step 430 with two or more of the landmarks in the map obtained at step 420. For example, process 400 can match two or more landmarks by comparing the landmarks detected at step 430 with the landmarks in the map obtained at step 420. In some examples, process 400 can compare the classifications (e.g., the type of landmarks) and/or the dimensions of the landmarks detected at step 430 with the landmarks in the map obtained at step 420 (e.g., to identify known landmark patterns). In some examples, process 400 can match the landmarks detected by the vehicle's sensor(s) at step 440 to the landmarks in the map obtained at step 420 by calculating the distances between two or more of the landmarks detected by the vehicle's sensor(s) at step 430 and comparing those calculated distances to the distances between two or more landmarks in the map obtained at step 420. In some examples, process 400 can determine the distances between two or more landmarks detected by the vehicle's sensor(s) at step 430 by using the distances from the vehicle to each of the landmarks and the angles from the vehicle's estimated heading to each of the landmarks (e.g., as described in further detail below). In some examples, process 400 will match two or more landmarks contained within the area defined by the error bounds to two or more landmarks from the map obtained at step 420. In some examples, process 400 will match two or more landmarks outside of the area defined by the error bounds to two or more landmarks from the map obtained at step 420. In some examples, process 400 will match at least one landmark contained within the error bounds of the vehicle's estimated location and at least one landmark outside of the error bounds of the vehicle's estimated location to two or more landmarks from the map obtained at step 420. In some examples, process 400 will determine the location and heading of the sensor used to detect the landmarks surrounding the vehicle (e.g., a LIDAR sensor mounter on the hood of the car) and convert that location and heading of the sensor to the vehicle's location (e.g., convert a single point location to the location of the entire car) and heading (e.g., convert the heading from being relative to the sensor to being relative to the center of the front bumper if driving forward or relative to the center of the back bumper if driving in reverse) at step 450.

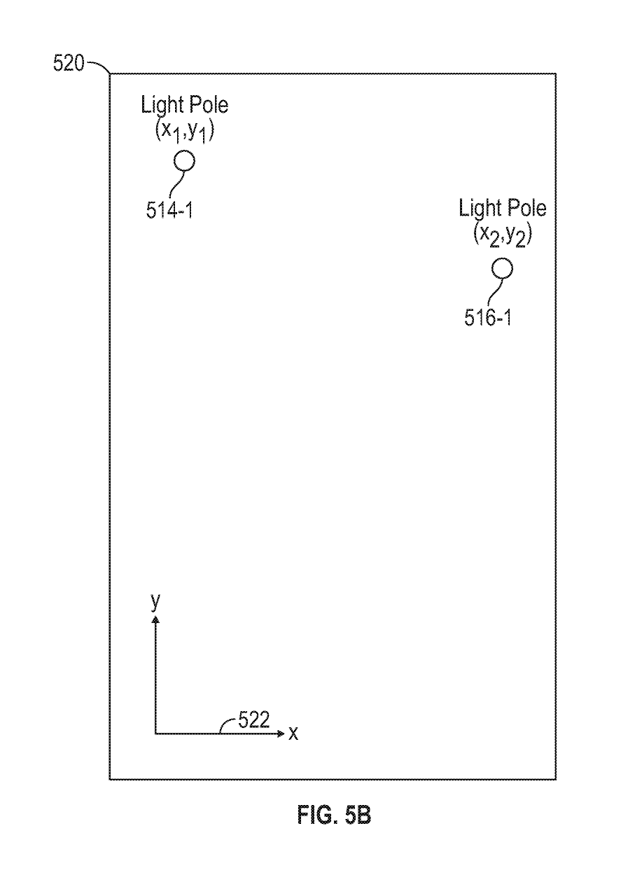

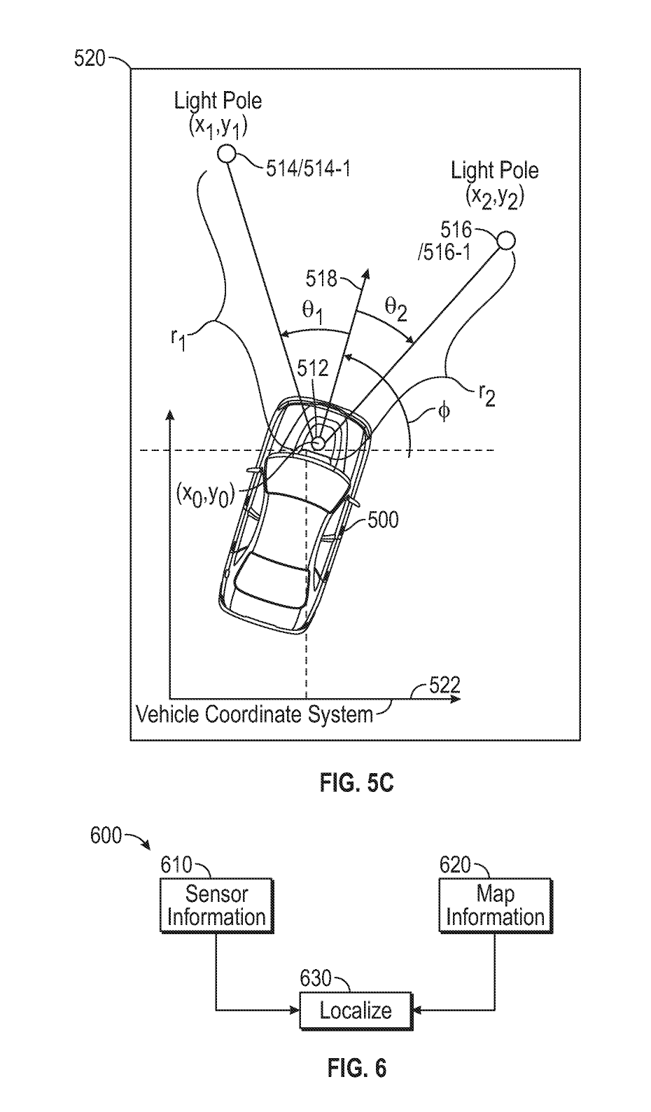

FIG. 5A illustrates vehicle sensor information 510 according to examples of the disclosure. For example, FIG. 5A illustrates vehicle 500 with sensor 512 detecting landmark 514 and landmark 516. In some examples, sensor information can also include the distance r₁ from sensor 512 to landmark 514 and angle θ₁ from the sensor's heading 518 (e.g., the vehicle's heading) to landmark 514. In some examples, sensor information can also include the distance r₂ from sensor 512 to landmark 516 and angle θ₂ from the sensor's heading 518 (e.g., the vehicle's heading) to landmark 514. In some examples, sensor information 510 can include a classification of landmark 514 and landmark 516 (e.g., whether each landmark is a light-pole, signal-pole, telephone pole, power-line pole, traffic sign, street sign, traffic signal, tree, lane divider, road marking, pillar, file hydrant, building, wall, fence, or any other fixed object or structure that can serve as a landmark for a geographic area). In some examples, sensor information can include the distance between landmark 514 and landmark 516. In some examples, sensor information can include the dimensions of landmark 514 and landmark 516. In some examples, sensor 512 can detect additional landmarks (e.g., as described above with reference to FIG. 4). In some examples, sensor information can include detailed information about other characteristics surrounding vehicle 500 (e.g., information about pedestrians, other vehicles, etc.). It should be noted that sensor 512 can represent one or more sensors and the one or more sensors could be placed anywhere throughout the vehicle (e.g., on the roof, on the trunk, behind any bumper, behind any windshield, underneath the vehicle).

FIG. 5B illustrates map information 520 according to examples of the disclosure. For example, map information 520 represents the map describing the location containing the estimated location of vehicle 500 of FIG. 5A. In some examples, the estimated location of the vehicle is represented by an error bounds (e.g., as described above with reference to FIGS. 3-4) and map information 520 can represent the geographic area that contains the area defined by the error bounds. In some examples, map information 520 is a two dimensional map with its own vehicle coordinate system 522 (e.g., coordinates in X and Y directions specific to the map) for navigation. In some examples, map information 520 can represent a three dimensional map (not shown). In some examples, map information 520 can include information about landmarks contained within the map. For example, map information 520 can include the coordinates of landmark 514-1 (e.g., x₁,y₁) and landmark 516-1 (e.g., x₂,y₂) and the classification/type of landmark 514-1 and landmark 516-1 (e.g., light poles). In some examples, map information 520 can also include the dimensions of landmark 514-1 and landmark 516-1 and the distance between landmark 514-1 and landmark 516-1 (not shown). It should be noted that while FIG. 5B illustrates two light poles, the disclosed invention also functions with other types of landmarks (e.g., signal-poles, telephone poles, power-line poles, traffic signs, street signs, traffic signals, trees, lane dividers, road markings, pillars, file hydrants, buildings, walls, fences, or any other fixed object or structure that can serve as a landmark for a geographic area). In some examples, map information 520 can include detailed information about roads, highways, freeways, etc. (e.g., including lane information, speed limits, traffic information, road conditions).

FIG. 5C illustrates vehicle 500 localized within map 520 based on sensor information 510 of FIG. 5A and map information 520 of FIG. 5B according to examples of the disclosure. For example, based on the distances from vehicle 500 to landmarks 514 and 516 (e.g., r₁ and r₂, respectively), the angles relative the vehicle's heading 518 to landmarks 514 and 516 (e.g., θ₁ and θ₂, respectively), and the coordinates of landmarks 514-1 and 516-1 from map information 520, vehicle 500's onboard computer can determine the location (e.g., x₀,y₀) and direction (Φ) of the vehicle within vehicle coordinate system 522 (e.g., as described in further detail below). In some examples, vehicle 500 can be localized within map 520 by matching landmarks 514 and 516 from sensor information 510 to landmarks 514-1 and 516-1 (e.g., as described above with reference to FIG. 2-4). For example, the vehicle's onboard computer can match landmarks 514 and 516 from the sensor information 510 to landmarks 514-1 and 516-1 from the map information 520 by detecting known characteristics of landmarks 514-1 and 516-1 in landmarks 514 and 516, respectively. In some examples, vehicle 500 can compare the classifications (e.g., the type of landmarks) and/or the dimensions of landmarks 514 and 516 with landmarks 514-1 and 516-1. In some examples, process 400 of FIG. 4 can match the landmarks 514 and 516 to the landmarks 514-1 and 516-1 by calculating the distance between landmarks 514 and 516 and comparing that calculated distance to the known distance between 514-1 and 516-1.

FIG. 6 illustrates process 600 for localizing a vehicle within a map according to examples of the disclosure. In some examples, process 600 can be performed continuously or repeatedly during driving procedures. In some examples, steps 610 and 620 can be performed serially (e.g., step 610 first and step 620 second, or vice versa). In some examples, steps 610 and 620 can be performed concurrently.

At step 610, sensor information is obtained (e.g., as described above with reference to FIGS. 1-4). For example, the area surrounding a vehicle can be scanned by the vehicle's one or more sensors and systems for determining one or more characteristics about the vehicle's surroundings (e.g., as described above with reference to FIG. 1-5). The sensor(s) for determining the one or more characteristics about the vehicle's surroundings can include LIDAR sensors, cameras (e.g., stereo-cameras, mono-cameras), radar sensors, ultrasonic sensors, laser sensors, or any other sensors that can be used to detect one or more characteristics about the vehicle's surroundings (e.g., as described above with reference to FIG. 1-5). In some examples, process 600 can scan the area defined by the error bounds of the vehicle's estimated location (e.g., as described above with reference to FIGS. 3-4). In some examples, process 600 can scan the entire area within the range of the vehicle's sensors. In some examples, process 600 can scan the area within the range of the vehicle's sensors and return information about two or more of the closest landmarks to the vehicle. For example, at step 610, process 600 can return the distance from the vehicle to a first landmark (e.g., r₁), the angle (θ₁) to the first landmark relative to the heading of the vehicle (e.g., relative to the sensor used to detect the first landmark), the distance from the vehicle to a second landmark (e.g., r₂), the angle (θ₂) to the second landmark relative to the heading of the vehicle (e.g., relative to the sensor used to detect the first landmark) (e.g., as described above with reference to FIG. 5A). In some examples, process 600 can return the distances and angles to additional landmarks (e.g., as described above with reference to FIG. 2-5).

At step 620, map information is obtained (e.g., as described above with reference to FIGS. 1-5). In some examples, this map information can be requested based on the vehicle's estimated location (e.g., as described above with reference to FIGS. 1-5). In some examples, the map information can be stored locally or remotely (e.g., as described above with reference to FIGS. 1-5). In some examples, the map information can be a simple two-dimensional map with its own coordinate system (e.g., X and Y coordinates) (e.g., as described above with reference to FIG. 5B). In some examples, the map information can be a three-dimensional map with its own coordinate system (e.g., X, Y, and Z coordinates). In some example, the map information can include the coordinates for landmarks (e.g., light-poles, signal-poles, telephone poles, power-line poles, traffic signs, street signs, traffic signals, trees, lane dividers, road markings, pillars, file hydrants) and other structures (e.g., buildings, walls) (e.g., as described above with reference to FIG. 5B). In some examples, the map information can contain detailed information about roads, highways, freeways, landmarks, buildings, etc.

At step 630, process 600 localizes the vehicle within the map obtained at step 620. For example, process 600 can determine the vehicle's location and heading within the map's coordinate system by matching two or more of the landmarks detected by the vehicle's sensor(s) at step 610 to two or more of the landmarks in the map obtained at step 620 (e.g., as described above with reference to FIG. 1-5). In some examples, process 600 can determine the location (e.g., x₀,y₀) and direction (Φ) of the vehicle within the map's vehicle coordinate system based on the distances from the vehicle to the first landmark and from the vehicle to the second landmark (e.g., r₁ and r₂, respectively) and the angles from the vehicle to each of the first landmark and to the second landmark relative to the vehicle's heading (e.g., θ₁ and θ₂, respectively) from the sensor information obtained at step 610, and the known locations of the first landmark and the second landmark from the map information obtained at step 620 (e.g., as described above with reference to FIG. 5C). For example, the vehicle's location (e.g., x₀,y₀) and direction (Φ) within the map's vehicle coordinate system can be determined with the following equations based on the sensor information obtained at step 610 and the map information obtained at step 620:

$$\{ \begin{matrix}{x}_{o} \\ {y}_{o}\end{matrix} \} = \frac{1}{2} \{ \begin{matrix}( {x}_{1} + {x}_{2} ) \\ ( {y}_{1} + {y}_{2} )\end{matrix} \} - \frac{( {r}_{2}^{2} - {r}_{1}^{2} )}{2 ( Δ {x}^{2} + Δ {y}^{2} )} \{ \begin{matrix}Δ x \\ Δ y\end{matrix} \} \{ \begin{matrix}Δ x \\ Δ y\end{matrix} \} = \{ \begin{matrix}{x}_{2} - {x}_{1} \\ {y}_{2} - {y}_{1}\end{matrix} \}$$

$$\{ \begin{matrix}cos φ \\ sin φ\end{matrix} \} = \frac{1}{Δ {x}^{2} + Δ {y}^{2}} [ \begin{matrix}( {r}_{2} cos {θ}_{2} - {r}_{1} cos {θ}_{1} ) & ( {r}_{2} sin {θ}_{2} - {r}_{1} sin {θ}_{1} ) \\ - ( {r}_{2} sin {θ}_{2} - {r}_{1} sin {θ}_{1} ) & ( {r}_{2} cos {θ}_{2} - {r}_{1} cos {θ}_{1} )\end{matrix} ] \{ \begin{matrix}Δ x \\ Δ y\end{matrix} \}$$

It should be understood that the above calculation and be extended to three or more landmarks.

Thus, the examples of the disclosure provide various ways to enhance localization techniques for safe autonomous vehicle navigation.

Therefore, according to the above, some examples of the disclosure are directed to a system for use in a vehicle, the system comprising: one or more sensors; one or more processors coupled to the one or more sensors; and a memory including instructions, which when executed by the one or more processors, cause the one or more processors to perform a method comprising the steps of: determining an estimated location of the vehicle; obtaining map information based on the estimated location of the vehicle; obtaining sensor information relating the vehicle's proximate surroundings from the one or more sensors; detecting a first landmark and a second landmark in physical proximity to the vehicle based on the sensor information; and localizing the vehicle location based on the map information and the first and second landmarks. Additionally or alternatively to one or more of the examples disclosed above, in some examples, the map information includes information about a plurality of landmarks. Additionally or alternatively to one or more of the examples disclosed above, in some examples, localizing the vehicle based on the map information and the first and second landmarks comprises the steps of: matching the first landmark to a third landmark of the plurality of landmarks and the second landmark to a fourth landmark of the plurality of landmarks; and determining a location and heading of the vehicle based on the vehicle's distance and orientation to the first and second landmarks. Additionally or alternatively to one or more of the examples disclosed above, in some examples, the first and second landmarks comprise street light-poles. Additionally or alternatively to one or more of the examples disclosed above, in some examples, the estimated location of the vehicle comprises an error bounds defining an area in which the vehicle is likely located. Additionally or alternatively to one or more of the examples disclosed above, in some examples, obtaining the map information based on the estimated location of the vehicle comprises retrieving map containing the area defined by the error bounds. Additionally or alternatively to one or more of the examples disclosed above, in some examples, the map information is retrieved from the memory. Additionally or alternatively to one or more of the examples disclosed above, in some examples, the map information is retrieved from a remote server. Additionally or alternatively to one or more of the examples disclosed above, in some examples, matching the first landmark to the third landmark and the second landmark to the fourth landmark further comprises the steps of: comparing the first and second landmarks to the plurality of landmarks; and identifying the first landmark as the third landmark and second landmark as the fourth landmark by landmark types and dimensions. Additionally or alternatively to one or more of the examples disclosed above, in some examples, matching the first landmark to the third landmark and the second landmark to the fourth landmark comprises: calculating a first distance between the first and second landmarks; comparing the first and second landmarks to the plurality of landmarks; and identifying the first landmark as the third landmark and second landmark as the fourth landmark in accordance with a determination that the first distance matches a second distance between the third landmark and the fourth landmark. Additionally or alternatively to one or more of the examples disclosed above, in some examples, determining the location and heading of the vehicle based on the vehicle's distance and orientation to the first and second landmarks comprises the steps of: determining a first distance from the vehicle to the first landmark; determining a first angle from the vehicle to the first landmark relative to an estimated heading of the vehicle; determining a second distance from the vehicle to the second landmark; determining a second angle from the vehicle to the second landmark relative to the estimated heading of the vehicle; and determining the location and heading of the vehicle based on the first distance, the first angle, the second distance, and the second angle. Additionally or alternatively to one or more of the examples disclosed above, in some examples, the first landmark is located within the error bounds and the second landmark is located outside of the error bounds. Additionally or alternatively to one or more of the examples disclosed above, in some examples, the map information comprises a map of a parking lot. Additionally or alternatively to one or more of the examples disclosed above, in some examples, obtaining the map information comprises a step of requesting a map containing the estimated location of the vehicle from a server. Additionally or alternatively to one or more of the examples disclosed above, in some examples, detecting the first landmark and the second landmark near the vehicle based on the sensor information comprises the steps of: detecting at least one characteristic about the vehicle's surroundings with the one or more sensors; classifying a first object of the one or more characteristics by landmark type; classifying a second object of the one or more characteristics by landmark type; and identifying the first object as the first landmark and the second object as the second landmark. Additionally or alternatively to one or more of the examples disclosed above, in some examples, the landmark types include signal-poles, telephone poles, power-line poles, traffic signs, street signs, traffic signals, trees, lane dividers, road markings, pillars, file hydrants, buildings, walls, and fences. Additionally or alternatively to one or more of the examples disclosed above, in some examples, the step of localizing the vehicle location includes determining a location and heading of the vehicle within a vehicle coordinate system. Additionally or alternatively to one or more of the examples disclosed above, in some examples, the first landmark is a first landmark type and the second landmark is a second landmark type.

Some examples of the disclosure are directed to a non-transitory computer-readable medium including instructions, which when executed by one or more processors, cause the one or more processors to perform a method comprising: determining an estimated location of a vehicle; obtaining map information based on the estimated location of the vehicle; obtaining sensor information about the vehicle's surroundings from one or more sensors; detecting a first landmark and a second landmark near the vehicle based on the sensor information; and localizing the vehicle based on the map information and the first and second landmarks.

Some examples of the disclosure are directed to a method comprising: determining an estimated location of a vehicle; obtaining map information based on the estimated location of the vehicle; obtaining sensor information about the vehicle's surroundings from one or more sensors; detecting a first landmark and a second landmark near the vehicle based on the sensor information; and localizing the vehicle based on the map information and the first and second landmarks.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

1. A system for use in a vehicle, the system comprising:
one or more sensors;
one or more processors coupled to the one or more sensors; and
a memory including instructions, which when executed by the one or more processors, cause the one or more processors to perform a method comprising the steps of:
determining an estimated location of the vehicle;
obtaining map information based on the estimated location of the vehicle;
obtaining sensor information relating the vehicle's proximate surroundings from the one or more sensors;
detecting a first landmark and a second landmark in physical proximity to the vehicle based on the sensor information; and
localizing the vehicle location based on the map information and the first and second landmarks.

2. The system of claim 1, wherein the map information includes information about a plurality of landmarks.

3. The system of claim 2, wherein localizing the vehicle based on the map information and the first and second landmarks comprises the steps of:
matching the first landmark to a third landmark of the plurality of landmarks and the second landmark to a fourth landmark of the plurality of landmarks; and
determining a location and heading of the vehicle based on the vehicle's distance and orientation to the first and second landmarks.

4. The system of claim 3, wherein the first and second landmarks comprise street light-poles.

5. The system of claim 3, wherein the estimated location of the vehicle comprises an error bounds defining an area in which the vehicle is likely located.

6. The system of claim 5, wherein obtaining the map information based on the estimated location of the vehicle comprises retrieving map containing the area defined by the error bounds.

7. The system of claim 6, wherein the map information is retrieved from the memory.

8. The system of claim 6, wherein the map information is retrieved from a remote server.

9. The system of claim 3, wherein matching the first landmark to the third landmark and the second landmark to the fourth landmark further comprises the steps of:
comparing the first and second landmarks to the plurality of landmarks; and
identifying the first landmark as the third landmark and second landmark as the fourth landmark by landmark types and dimensions.

10. The system of claim 3, wherein matching the first landmark to the third landmark and the second landmark to the fourth landmark comprises:
calculating a first distance between the first and second landmarks;
comparing the first and second landmarks to the plurality of landmarks; and
identifying the first landmark as the third landmark and second landmark as the fourth landmark in accordance with a determination that the first distance matches a second distance between the third landmark and the fourth landmark.

11. The system of claim 3, wherein determining the location and heading of the vehicle based on the vehicle's distance and orientation to the first and second landmarks comprises the steps of:
determining a first distance from the vehicle to the first landmark;
determining a first angle from the vehicle to the first landmark relative to an estimated heading of the vehicle;
determining a second distance from the vehicle to the second landmark;
determining a second angle from the vehicle to the second landmark relative to the estimated heading of the vehicle; and
determining the location and heading of the vehicle based on the first distance, the first angle, the second distance, and the second angle.

12. The system of claim 5, wherein the first landmark is located within the error bounds and the second landmark is located outside of the error bounds.

13. The system of claim 1, wherein the map information comprises a map of a parking lot.

14. The system of claim 1, wherein obtaining the map information comprises a step of requesting a map containing the estimated location of the vehicle from a server.

15. The system of claim 1, wherein detecting the first landmark and the second landmark near the vehicle based on the sensor information comprises the steps of:
detecting at least one characteristic about the vehicle's surroundings with the one or more sensors;
classifying a first object of the one or more characteristics by landmark type;
classifying a second object of the one or more characteristics by landmark type; and
identifying the first object as the first landmark and the second object as the second landmark.

16. The system of claim 15, wherein the landmark types include signal-poles, telephone poles, power-line poles, traffic signs, street signs, traffic signals, trees, lane dividers, road markings, pillars, file hydrants, buildings, walls, and fences.

17. The system of claim 1, wherein the step of localizing the vehicle location includes determining a location and heading of the vehicle within a vehicle coordinate system.

18. The system of claim 1, wherein the first landmark is a first landmark type and the second landmark is a second landmark type.

19. A non-transitory computer-readable medium including instructions, which when executed by one or more processors, cause the one or more processors to perform a method comprising:
determining an estimated location of a vehicle;
obtaining map information based on the estimated location of the vehicle;
obtaining sensor information about the vehicle's surroundings from one or more sensors;
detecting a first landmark and a second landmark near the vehicle based on the sensor information; and
localizing the vehicle based on the map information and the first and second landmarks.

20. A method comprising:
determining an estimated location of a vehicle;
obtaining map information based on the estimated location of the vehicle;
obtaining sensor information about the vehicle's surroundings from one or more sensors;
detecting a first landmark and a second landmark near the vehicle based on the sensor information; and
localizing the vehicle based on the map information and the first and second landmarks.
